(19) United States
(12) Patent Application Publication
(10) Pub. No.: US 2020/0179822 A1
(43) Pub. Date: Jun. 11, 2020

(54) GREASE TRAP

(71) Applicant: Lyle Burns, Albuquerque, NM (US)

(72) Inventor: Lyle Burns, Albuquerque, NM (US)

(21) Appl. No.: 16/682,392

(22) Filed: Nov. 13, 2019

Related U.S. Application Data
(60) Provisional application No. 62/777,863, filed on Dec. 11, 2018.

(51) Int. Cl. B01D 17/02

(52) U.S. Cl. CPC B01D 17/0211; B01D 17/12; B01D 17/0214

(57) ABSTRACT

A grease trap (and concomitant method comprising a separator unit separating grease from other fluids and receiving a fluid train containing grease, a heated catch basin beneath the separator unit that receives the separated grease and prevents it from solidifying, a pipe leading downward from the heated catch basis, and a grease container receiving separated grease from a lower end of the pipe.

### CROSS-REFERENCE TO RELATED APPLICATIONS

This application claims priority to and the benefit of the filing of U.S. Provisional Patent Application Ser. No. 62/777,863, filed on Dec. 11, 2018, and the specifications and claims thereof are incorporated herein by reference.

### STATEMENT REGARDING FEDERALLY SPONSORED RESEARCH OR DEVELOPMENT

Not Applicable.

### NAMES OF PARTIES TO JOINT RESEARCH AGREEMENT

Not Applicable.

### REFERENCE TO A SEQUENCE LISTING, A TABLE, OR A COMPUTER PROGRAM LISTING COMPACT DISC APPENDIX

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention (Technical Field)

The present invention relates to a grease trap, particularly useful for restaurants and other facilities with large cooking stoves and/or grills.

### DESCRIPTION OF RELATED ART

Restaurants typically vent their cooking equipment (e.g., grills) to the roof of the establishment, which results in collection of grease particles on the roof, with concomitant mess, fire danger, and possible roof damage over time. The present invention provides a more suitable manner to deal with vented grease.

### BRIEF SUMMARY OF THE INVENTION

The present invention is of a grease trap comprising: a separator unit separating grease from other fluids and receiving a fluid train containing grease; a heated catch basin beneath the separator unit that receives the separated grease and prevents it from solidifying; a pipe leading downward from the heated catch basis; and a grease container receiving separated grease from a lower end of the pipe. In certain embodiments, the separator unit comprises one or more baffles (preferably at least two) to disrupt fluid flow. The pipe may comprise PVC, and may be insulated. A flexible nozzle (e.g., a hose) can connect the pipe to the grease container. The grease container is preferably removable. The separator unit and the heated catch basis can be located on a rooftop, with the grease container then being located at ground level.

The invention is also of a method of capturing grease with a grease trap, the method comprising: separating grease from other fluids via a separator unit receiving a fluid train containing grease; heating a catch basin beneath the separator unit that receives the separated grease and prevents it from solidifying; allowing the separated grease to flow downward via a pipe leading downward from the heated catch basis; and receiving via a grease container separated grease from a lower end of the pipe. In certain embodiments, the method includes disrupting fluid flow in the separator unit via one or more baffles (e.g., at least two). The pipe may be of PVC, and may be insulated. The method may including connecting a flexible nozzle (e.g., a hose) from the pipe to the grease container. The grease container is preferably removable. The separator unit and the heated catch basis can be located on a rooftop, with the grease container then being located at ground level.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE VIEWS OF THE DRAWINGS

The accompanying drawing, which is incorporated into and forms a part of the specification, illustrates one or more embodiments of the present invention and, together with the description, serves to explain the principles of the invention. The drawing is only for the purpose of illustrating one or more preferred embodiments of the invention and is not to be construed as limiting the invention. In the drawings:

FIG. 1 is a schematic diagram of the preferred grease trap of the invention.

### DETAILED DESCRIPTION OF THE INVENTION

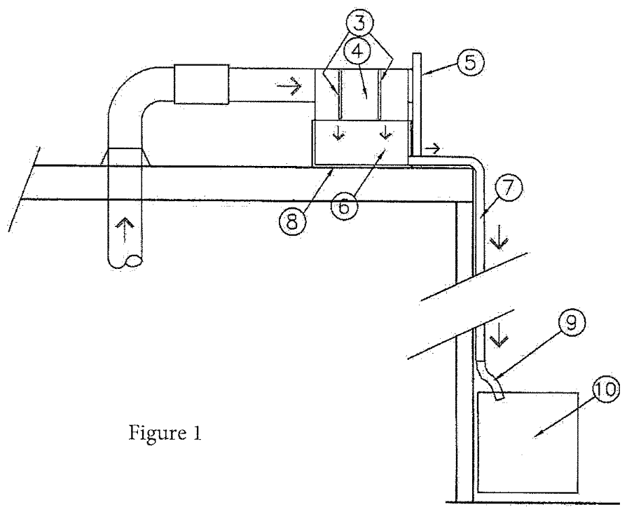

The present invention is of a grease trap, shown in FIG. 1, which employs one or more of the following concepts: Baffles are placed to disrupt/restrain fluid flow within a separator used to separate grease from fluid. A backstop is used for supporting the structure of the assembly. A catch basin is used to collect trapped grease and a heat rod is provided for the catch basin in order to prevent solidification of collected grease. Piping, preferably of PVC (polyvinyl chloride) pipe, is used for transferring collected grease to the container which is provided with a flexible and adjustable nozzle (hose) to transfer grease from the PVC pipe to the container.

As shown in FIG. 1, the present invention discloses a grease trap and concomitant process comprising one or more of the following elements:

1. Baffles 3 are preferably provided to disrupt/restrain fluid flow. They are preferably offset, with each spanning half the width of the separator unit.

2. Separator 4 is preferably used to separate grease from fluid. It preferably comprises a heating component and air escape holes in removable sides. It is preferably provided with a vent exhaust by piping, which can be metal, PVC (polyvinyl chloride), etc.

3. Backstop 5 is preferably used for supporting the structure.

4. Catch basin 6 is preferably used to collect trapped grease. It is preferably heated, causing grease to drain into piping, preferably of PVC.

5. Pipe 7 (preferably insulated and/or made of PVC) is preferably employed for transferring collected grease to the container 10. The pipe is preferably heat-tape wrapped, with a hose 9 at the container end.

6. Heat rod 8 is preferably employed at catch basin 6 to prevent solidification of collected grease.

7. Flexible/adjustable nozzle (hose) 9 is preferably employed to transfer grease from pipe 7 to container 10.

8. Removable grease container 10 is preferably employed to collect the grease from catch basin 6 at the ground level (or lower roof level) for removal and disposal.

While the invention can be directed to use in restaurants, the invention is also useful in any commercial, residential, or industrial setting requiring collection of (rather than venting of) grease and like contaminants. In that grease can be converted to other forms of energy, the collected grease can be a further source of income and/or energy.

Embodiments of the present invention provide a technology-based solution that overcomes existing problems with the current state of the art in a technical way to satisfy an existing problem for restaurants and other facilities with large cooking stoves and/or grills.

Note that in the specification and claims, “about” or “approximately” means within ten percent (10%) of the numerical amount cited.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A grease trap comprising:
a separator unit separating grease from other fluids and receiving a fluid train containing grease;
a heated catch basin beneath said separator unit that receives the separated grease and prevents it from solidifying;
a pipe leading downward from said heated catch basis; and
a grease container receiving separated grease from a lower end of said pipe.

2. The grease trap of claim 1 wherein said separator unit comprises one or more baffles to disrupt fluid flow.

3. The grease trap of claim 2 wherein said separator unit comprises at least two baffles.

4. The grease trap of claim 1 wherein said pipe comprises PVC.

5. The grease trap of claim 1 wherein said pipe is insulated.

6. The grease trap of claim 1 additionally comprising a flexible nozzle connecting said pipe to said grease container.

7. The grease trap of claim 6 wherein said flexible nozzle comprises a hose.

8. The grease trap of claim 1 wherein said grease container is removable.

9. The grease trap of claim 1 wherein said separator unit and said heated catch basis are located on a rooftop.

10. The grease trap of claim 9 wherein said grease container is located at ground level.

11. A method of capturing grease with a grease trap, the method comprising the steps of:
separating grease from other fluids via a separator unit receiving a fluid train containing grease;
heating a catch basin beneath the separator unit that receives the separated grease and prevents it from solidifying;
allowing the separated grease to flow downward via a pipe leading downward from the heated catch basis; and
receiving via a grease container separated grease from a lower end of the pipe.

12. The method of claim 11 additionally comprising disrupting fluid flow in the separator unit via one or more baffles.

13. The method of claim 12 employing at least two baffles.

14. The method of claim 11 wherein the pipe comprises PVC.

15. The method of claim 11 wherein the pipe is insulated.

16. The method of claim 11 additionally comprising connecting a flexible nozzle from the pipe to the grease container.

17. The method of claim 16 wherein the flexible nozzle comprises a hose.

18. The method of claim 11 wherein the grease container is removable.

19. The method of claim 11 wherein the separator unit and the heated catch basis are located on a rooftop.

20. The method of claim 19 wherein the grease container is located at ground level.
